(19) United States
(12) Patent Application Publication
(10) Pub. No.: US 2014/0067674 A1
(43) Pub. Date: Mar. 6, 2014

(54) SMARTPHONE BARCODE TRANSACTIONS

(71) Applicants: Marcel Leyva, Chandler, AZ (US); Francisco Mogollon, Scottsdale, AZ (US)

(72) Inventors: Marcel Leyva, Chandler, AZ (US); Francisco Mogollon, Scottsdale, AZ (US)

(73) Assignee: American Express Travel Related Services Company, Inc., New York, NY (US)

(21) Appl. No.: 13/604,976

(22) Filed: Sep. 6, 2012

(51) Int. Cl. G06Q 20/40

(52) U.S. Cl. 705/44

(57) ABSTRACT

Systems and methods for processing payments using a dynamic security code are provided. An account authorization system may generate a plurality of dynamic security codes and transmit the plurality of dynamic security codes to a portable consumer device. The portable consumer device may generate a payment code comprising a transaction account number and a dynamic security code. A merchant may scan the payment code and transmit a transaction request to the account authorization system. The account authorization system may compare the transaction account number and dynamic security code in the transaction request to a transaction account number and dynamic security code stored in a database. The account authorization system may transmit an authorization message to the merchant.

### FIELD

The present disclosure generally relates to financial transactions, and more particularly, a system and method of processing financial transactions using a dynamic security code.

### BACKGROUND

Counterfeit fraud is a major problem in markets using magnetic stripe static security code authentication to process card present transactions. In several markets around the world, the problem has been addressed by adopting Europay, Mastercard and Visa (“EMV”) technology, which uses dynamic authentication. However, EMV requires significant cost for merchants to replace millions of terminals and subsequent changes across entire payment networks.

Additionally, consumers desire the ability to engage in financial transactions without the necessity of carrying a transaction instrument. Some mobile phones possess Near Field Communication (“NFC”) capabilities which allow financial transactions. However, such phones have not reached significant market penetration and are incapable of engaging in transactions with many existing systems.

With the increased popularity in online shopping, the numbers of Card Not Present (“CNP”) transactions have increased rapidly in recent years. CNP transactions carry an additional risk of fraud, as the merchant has little assurance that the consumer using a transaction account number to facilitate a purchase transaction is in fact the authorized user of the transaction account. In order to add assurance that the consumer is in possession of a transaction instrument, many merchant web sites require the consumer to enter a card security code or Card Identification Number (CID), often printed on the front and/or reverse side of the transaction instrument. The CID may comprise any number of characters comprising any combination of numbers, symbols, letters, or other indicia.

However, as is the case with providing transaction account information to a merchant, the risk of an employee of the merchant obtaining the transaction account information and using it fraudulently remains, even with the use of a CID. Therefore, some account issuers have sought to overcome this problem by bypassing the merchant and providing a static password or CID directly to the account issuer to be paired with other transaction account information for authorization. However, such a process has required online merchants to make significant changes to their web sites, has extended the time for completing the purchasing process, and has required consumers to complete a sign-up process for such an addition services. For example, merchant web sites employing this type of security configuration often rely on a separate window or pop-up to collect the CID from the account holder. In this manner, the CID can be isolated from other transaction account information and transmitted directly to the account issuer, thereby eliminating the possibility of exposing the static password or CID to the merchant. However, many consumers abort a transaction when required to enter additional information into a pop-up window, or when required to sign-up for a new security service in order to complete a transaction. Moreover, such a system for bypassing a merchant may not be necessary if a dynamic CID is used because the CID may change with each transaction.

### SUMMARY

The present disclosure includes a system, method and computer program product for processing transactions using a dynamic security code. In various embodiments, a account authorization system may generate a plurality of dynamic security codes. The account authorization system may transmit the dynamic security codes to a portable consumer device. The portable consumer device may generate a payment code comprising a transaction account number and a dynamic security code. A merchant may scan the payment code on the portable consumer device. The account authorization system may receive a transaction request from a merchant or from the portable consumer device. The transaction request may comprise the transaction account number and the dynamic security code. The account authorization system may detect a dynamic security code in the transaction request and determine that the transaction account number and the dynamic security code match a transaction account number and dynamic security code stored on a database. The account authorization system may transmit an authorization message to the merchant.

The present disclosure includes a system, method and computer program product for facilitating transactions using a portable consumer device. In various embodiments, a method may include storing a plurality of dynamic security codes. The method may include scanning a payment code. Information in the payment code may be transmitted to an account authorization system in a transaction request. The method may include producing output to display a first dynamic security code.

### BRIEF DESCRIPTION OF THE DRAWINGS

A more complete understanding may be derived by referring to the detailed description and claims when considered in connection with the Figures, wherein like reference numbers refer to similar elements throughout the Figures, and:

FIG. 1 illustrates a block diagram of a system for processing transactions using a dynamic security code according to various embodiments of the disclosure;

FIG. 2 illustrates an example screen of a portable consumer device according to various embodiments;

FIG. 3 illustrates a block diagram of a system for processing transactions between a portable consumer device and a transaction instrument using a dynamic security code according to various embodiments;

FIG. 4 illustrates a block diagram of a system for processing transactions between a payor portable consumer device and a. payee portable consumer device using a dynamic security code according to various embodiments;

FIG. 5 illustrates a flow chart of a process for processing transactions using a dynamic security code according to various embodiments;

FIG. 6 illustrates an example screen of a portable consumer device with a payment code according to various embodiments;

FIG. 7 illustrates a flow chart of a process for processing transactions between a payor portable consumer device and a payee portable consumer device using a dynamic security code according to various embodiments;

FIG. 8 illustrates a portable consumer device and a transaction instrument with a payment code printed thereon according to various embodiments; and

FIG. 9 illustrates a flowchart depicting a process for facilitating a transaction using a portable consumer device according to various embodiments.

FIG. 10 illustrates a flowchart depicting a process for facilitating a transaction using a portable consumer device wherein the portable consumer device transmits a dynamic security code to an account authorization system according to various embodiments.

### DETAILED DESCRIPTION

The detailed description of exemplary embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

The phrases consumer, customer, user, account holder, cardmember or the like shall include any person, entity, business, government organization, business, software, hardware, machine associated with a transaction account, buys merchant offerings offered by one or more merchants using the account and/or who is legally designated for performing transactions on the account, regardless of whether a physical card is associated with the account. For example, the cardmember may include a transaction account owner, a transaction account user, an account affiliate, a child account user, a subsidiary account user, a beneficiary of an account, a custodian of an account, and/or any other person or entity affiliated or associated with a transaction account.

Systems, methods, and articles of manufacture capable of processing a transaction using a dynamic security code are disclosed herein. In various embodiments, an account authorization system may generate a plurality of dynamic security codes and store the plurality of dynamic security codes in a queue. In various embodiments, a portable consumer device may download a transaction application, The portable consumer device may download the plurality of dynamic security codes from the account authorization system. The portable consumer device may use the transaction application to generate a payment code comprising a transaction account number and a dynamic security code. A merchant may scan the payment code and transmit a transaction request to the account authorization system. The account authorization system may compare the transaction account number and the dynamic security code with information stored in a database. The account authorization system may transmit an authorization message to the merchant.

In various embodiments, the portable consumer device may scan a payment code and transmit a transaction request to the account authorization system. The account authorization system may initiate a communication session with a merchant point of sale device associated with the payment code. A consumer associated with the portable consumer device may input information such as a dynamic security code into the merchant point of sale device, and the merchant point of sale device may transmit the information to the account authorization system. The account authorization system may transmit an authorization message to the merchant point of sale device.

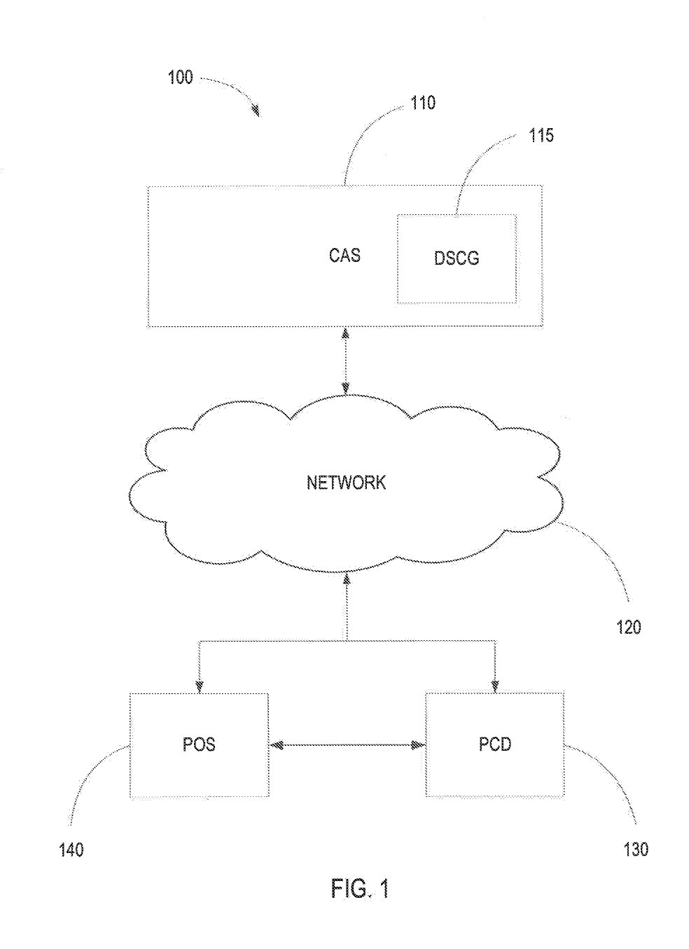

Referring to FIG. 1, a system 100 for processing payments using dynamic security codes is illustrated according to various embodiments. System 100 may comprise a Card Authorization System (“CAS”) 110, Network 120, a Portable Consumer Device (“PCD”) 130, and a merchant Point of Sale device (“POS”) 140. The various system components may communicate via network 120.

In various embodiments, CAS 110 (also known as an account authorization system) may be capable of or configured to perform all or part of an authorization process in relation to a payment transaction associated with a transaction account. CAS 110 may comprise any combination of hardware and software, such as servers, databases, firewalls, computers, etc., in order to authorize transactions. In various embodiments, CAS 110 may be operated by a payment processor (e.g., transaction account issuer).

In various embodiments, the system may comprise a dynamic security code generator (“DSCG”) 115. DSCG 115 may be a component of CAS 110. DSCG 115 may generate a plurality of dynamic security codes (“DSC”) for a transaction account. In various embodiments, the DSCs may be randomly generated. The DSCs may comprise a 5-digit security code; however, the DSCs may comprise any number of digits. The DSCs may be dynamic single-use security codes. DSCG 115 may store a plurality of DSCs for a transaction account in a database. The DSCs may be stored in a queue, such that only the DSC which is first in the queue is active. In various embodiments, the DSC may be entered into a standard CID field. The use of dynamic security codes is further described in U.S. Pat. No. 7,849,014 entitled “SYSTEM AND METHOD FOR FACILITATING A FINANCIAL TRANSACTION WITH A DYNAMICALLY GENERATED IDENTIFIER,” filed on Aug. 29, 2007, the contents of which are hereby incorporated by reference for any purpose in its entirety.

Network 120 may include any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN Tarry, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

PCD 130 may comprise any device capable of interacting with Network 120. In various embodiments, PCD may comprise a cellular phone. However, in various embodiments PCD 130 may comprise a smart card, PDA, laptop, personal computer, GPS device, car navigation system, web client, or any other device. Various types of web clients which may function as a PCD are described in further detail herein.

POS 140 may comprise any combination of hardware and/or software capable of facilitating a transaction between a consumer and a merchant. In various embodiments, POS 140 may comprise a cash register at a brick and mortar store. However, in various embodiments, POS 140 may comprise a website. POS 140 may comprise a gateway as described in further detail herein. POS may also comprise a PCD similar to PCD 130.

In various embodiments, PCD 130 may sync with CAS 110 to download the DSCs. In various embodiments, PCD 130 may generate the DSCs and PCD 130 may sync with CAS 110 to upload the DSCs. PCD 130 may automatically sync with CAS 110 in response to a predetermined number of unused security codes being stored in the memory of PCD 130. For example, in response to 5 or fewer security codes being present in the memory of PCD 130, PCD 130 may attempt to connect to CAS 110 and download additional security codes. PCD 130 may download a set number of security codes, for example ten security codes, each time PCD 130 downloads security codes. PCD 130 may download however many security codes are necessary such that PCD 130 stores a predetermined number of security codes. For example, in various embodiments PCD 130 may download enough security codes in order to store twenty security codes on PCD 130, regardless of how many security codes PCD 130 has stored prior to the download. PCD 130 may attempt to download a new security code each time a security code stored in the memory of PCD 130 is used. By storing multiple security codes in the memory of PCD 130, or by uploading multiple DSCs to CAS 110, a consumer may make purchases using a DSC even when PCD 130 is not in communication with CAS 110. In various embodiments, for even greater security, PCD 130 may only download or upload security codes in response to a consumer inputting verification information into PCD 130. In various embodiments, PCD 130 may transmit a request to reset the DSCs to CAS 110. For example, in response to a DSC in a transaction request from PCD 130 not matching a DSC stored by CAS 110, PCD 130 may transmit a request to reset the DSCs, and PCD 130 and CAS 110 may sync together with a new set of DSCs.

Each DSC may be a single-use security code. During a transaction, PCD 130 may use a DSC which is first in a queue on PCD 130 for a transaction request. CAS 110 may compare the DSC in the transaction request to a queue of DSCs stored in the database, and in response to the DSC in the transaction request matching the first DSC in the database queue, CAS 110 may approve the transaction request. In various embodiments, CAS 110 may authorize the request if the DSC in the transaction request matches any of the DSCs stored in the database queue. In response to the DSC in the transaction request not matching the first DSC in the database queue, CAS 110 may deny the transaction request. In response to a transaction using the first DSC in the database queue, CAS 110 may delete the first DSC and move a second DSC to the front of the database queue.

In various embodiments, a consumer may initiate the transaction application on PCD 130. The consumer may initiate the transaction application in a variety of ways, including tapping or clicking a button or other visual display, or by making a sound, such as a voice command. The transaction application may request that the consumer enter verification information. The verification information may include a password. The password may comprise any combination of letters and/or other characters, or may comprise making contact with a screen of PCD 130 with a finger or other object and moving across the screen in a predetermined pattern. Many methods of entering a password on a PCD are known in the art and are consistent with the present disclosure.

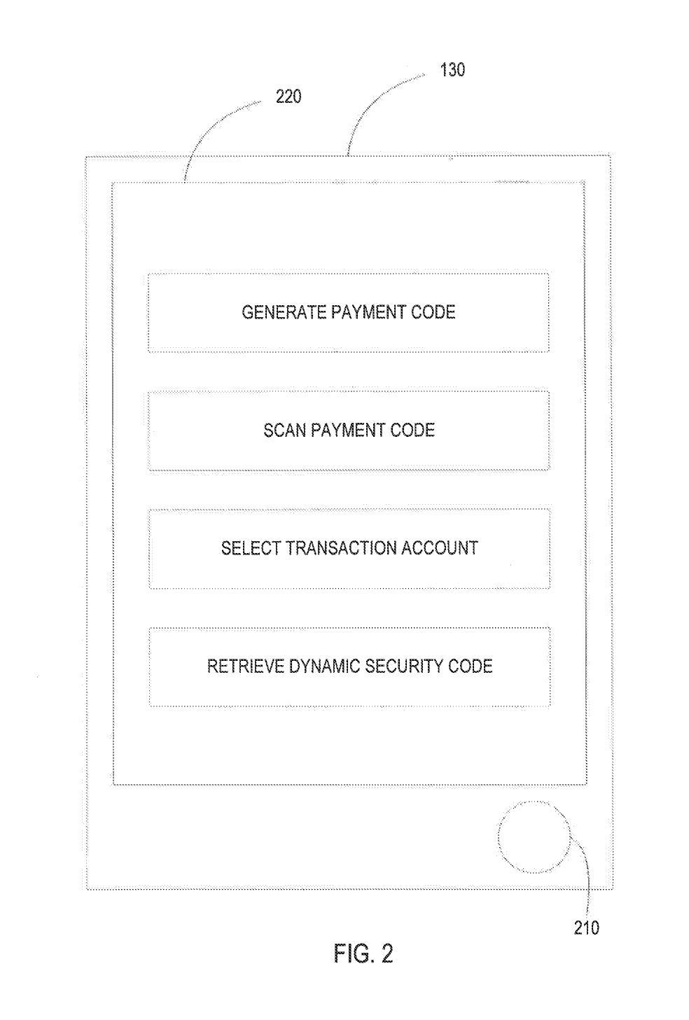

The transaction application may verify the verification information. In response to verifying the verification information, the transaction application may provide the user with a variety of options as illustrated in FIG. 2. The options may include generating a payment code, scanning a payment code, selecting a transaction account, and retrieving a dynamic security code. In various embodiments, the transaction application and/or PCD 130 may comprise a quick pay feature. For example, a quick pay button 210 on the exterior of PCD 130 may be pressed and, without interacting with a screen 220, the transaction application may generate a payment code which is displayed on the screen 220. In various embodiments the quick pay feature may be accessed by pressing a button and speaking a command. In various embodiments, in response to the quick pay feature being accessed, the transaction application may require the consumer to input verification information prior to displaying the payment code. In various embodiments, the verification information may comprise a spoken command or password. In various embodiments, the verification information may comprise biometric information, such as a retinal scan or detecting a fingerprint on PCD 130.

In various embodiments, PCD 130 or POS 140 may be configured with a biometric security system that may be used for providing biometrics as a secondary form of identification. The biometric security system may include a transponder and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof.

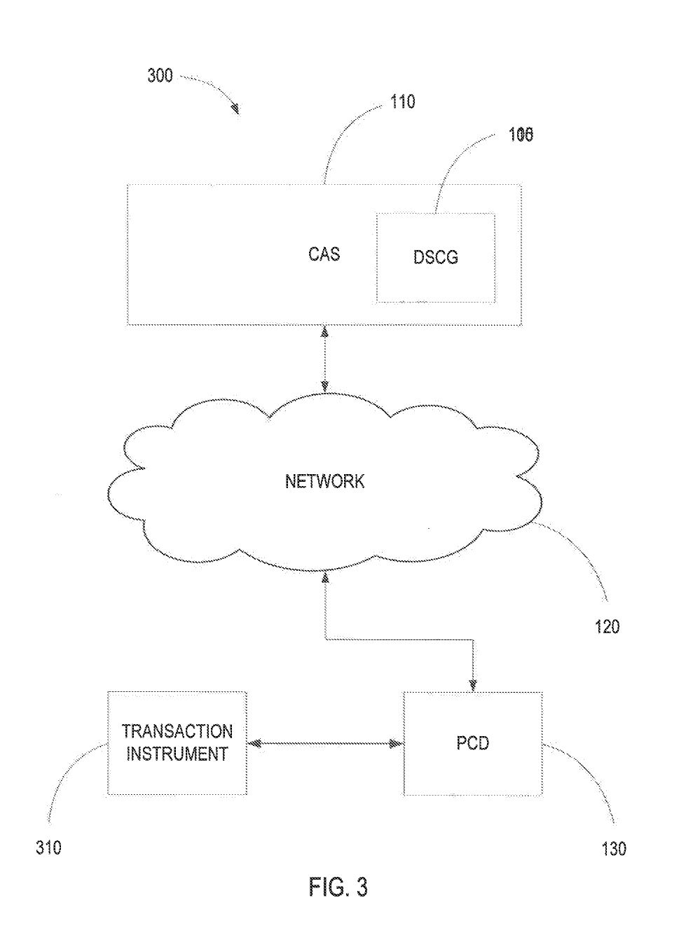

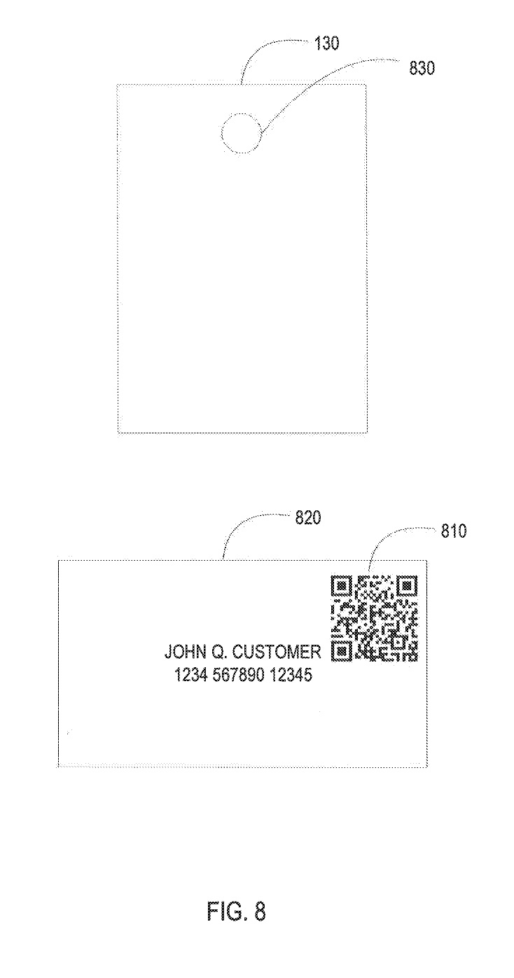

Referring to FIG. 3, a system 300 is illustrated according to various embodiments. In the system of FIG. 3, transactions may occur between PCD 130 and transaction instrument 310. For example, PCD 130 may scan a payment code printed on transaction instrument 310 and communicate with CAS 110 via network 120 to either receive a payment from or make a payment to a transaction account associated with transaction instrument 310. Methods consistent with system 300 are described in more detail below with reference to FIG. 8.

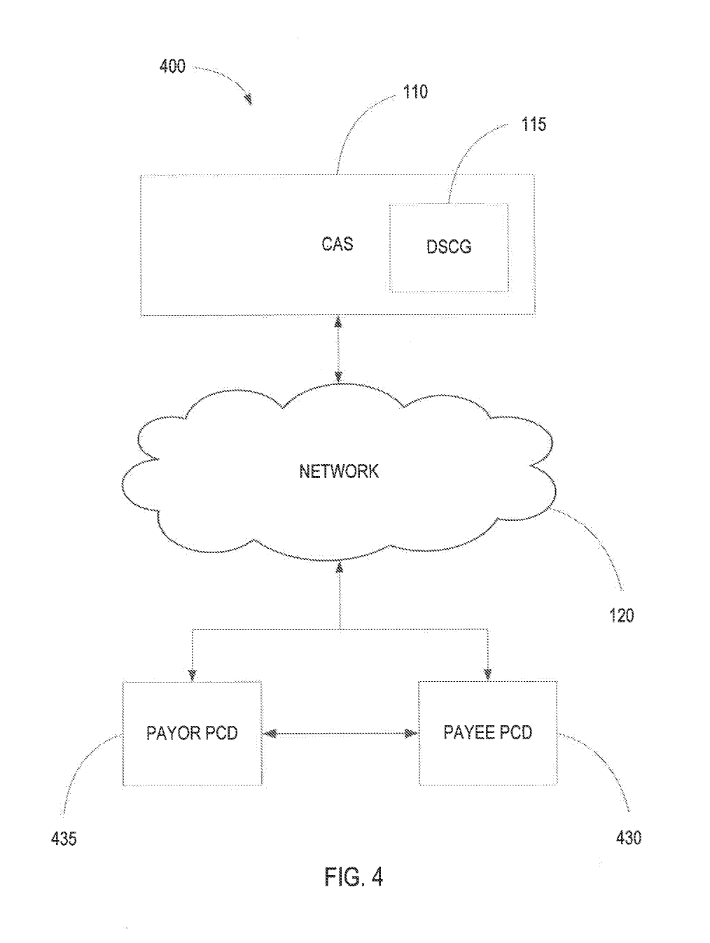

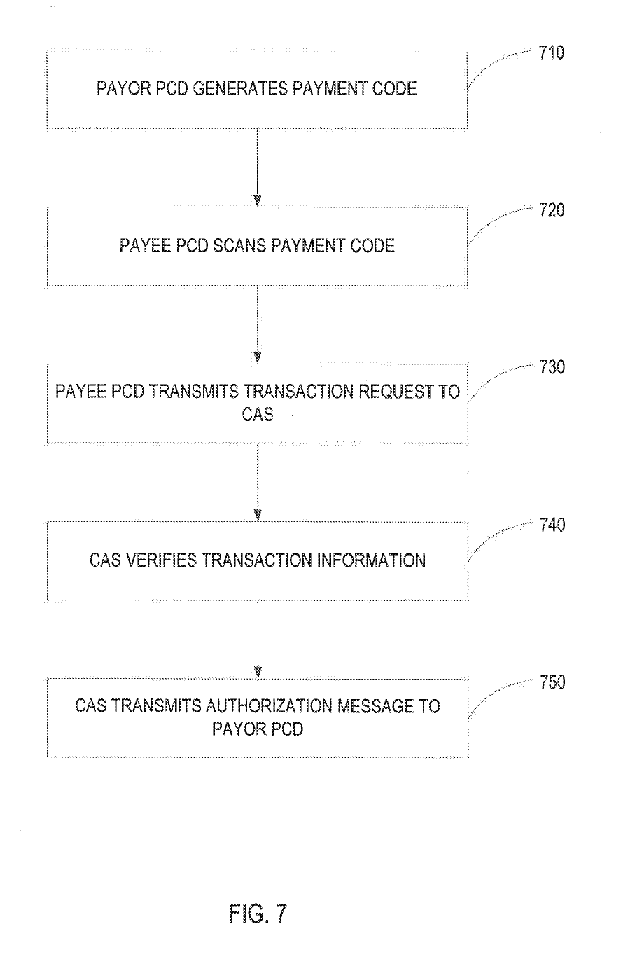

Referring to FIG. 4, a system 400 is illustrated according to various embodiments. In the system of FIG. 4, transactions may occur between a payee PCD 430 and payor PCD 435. For example, payee PCD 430 may scan a payment code displayed by payor PCD 435 and communicate with CAS 110 via network 120 to either receive a payment from or make a payment to a transaction account associated with payor PCD 435. Methods consistent with system 400 are described in more detail below with reference to FIG. 7.

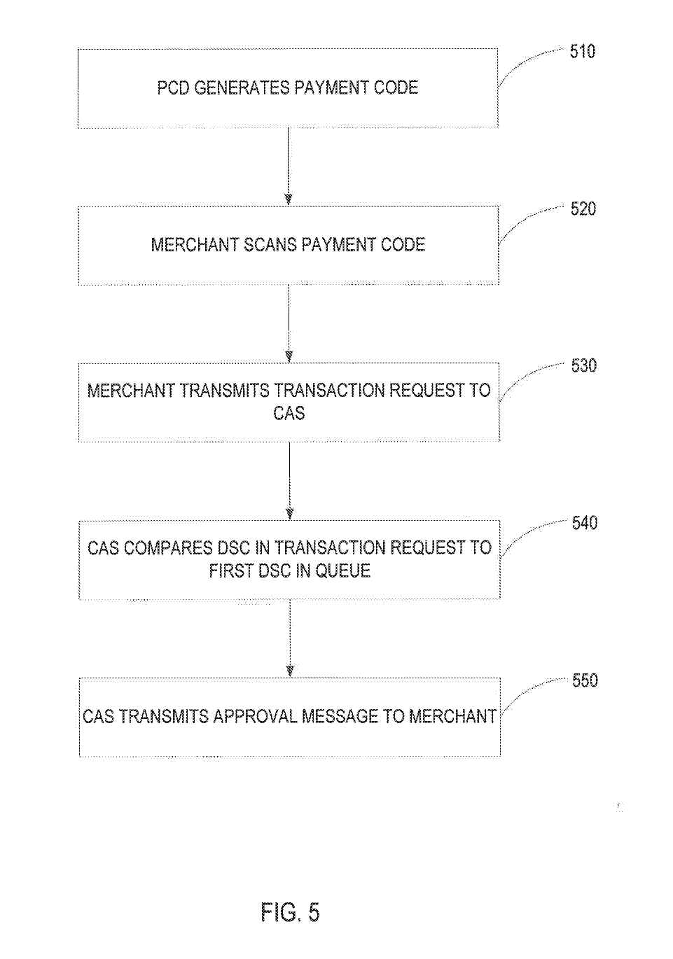

Referring to FIG. 5, a flowchart is illustrated according to various embodiments. In various embodiments, the consumer may wish to make a payment at a merchant. If the merchant has the capability to scan a payment code, the consumer may select the generate payment code option. In step 510, PCD 130 may generate a machine-readable payment code using the transaction application that comprises an account number associated with a transaction account, or a similar functioning number such as an alias, and a DSC. The payment code may comprise a QR code, a barcode, or any other graphical representation of data. In step 520, the merchant may scan the machine-readable code and create a transaction request. The transaction request may include the account number or alias and the DSC, as well as transaction specific information such as the transaction amount, a merchant service establishment number, or any other data which assists in processing a transaction. The transaction request may further include enhanced authorization data which may be checked against various fraud databases. In various embodiments, the enhanced authorization data may be contained in the payment code. The enhanced authorization data may include, for example, a telephone number, email address, PCD identification number, billing address, etc. In step 530, the merchant may transmit the transaction request to CAS 110.

CAS 110 may receive the transaction request and create an approval or denial message. In step 540, CAS 110 may detect a DSC in the transaction request. CAS 110 may compare the DSC in the transaction request with a list of DSCs associated with the consumer. In step 550, in response to the DSC in the transaction request matching the appropriate DSC. CAS 110 may generate an approval message and transmit the approval message to the merchant. In various embodiments, the appropriate DSC may be the first DSC in a queue of DSCs associated with the transaction account.

In various embodiments, the authorization system may transmit a transaction notification to PCD 130. The transaction notification may be sent within the transaction application. In various embodiments the transaction notification may be sent via a SMS, text, e-mail, or other method of communication. The transaction notification may require that the consumer confirm the transaction by clicking on a confirm button or by indicating their confirmation in any other manner. The transaction notification may require the consumer to enter a password or other verification information. In various embodiments, the CAS 110 may determine that the transaction was fraudulent based on the response from PCD 130.

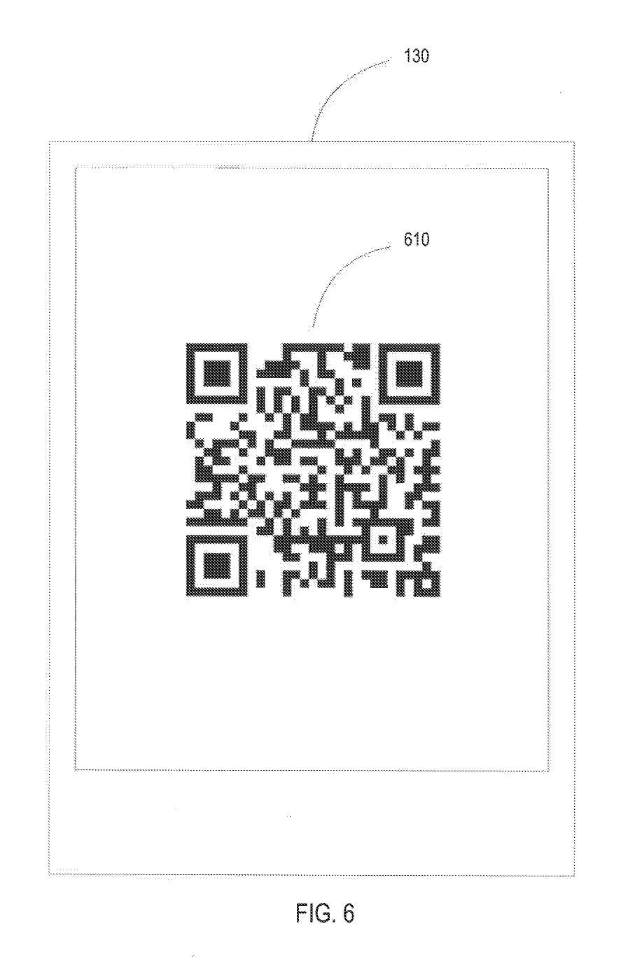

Referring to FIG. 6, a PCD 130 is illustrated according to various embodiments. PCD 130 is shown displaying a payment code 610. Payment code 610 comprises an account number 1234 567890 12345 and a DSC 67890. In various embodiments, the account number may be stored on PCD 130, and a plurality of DSCs may be stored on PCD 130. The transaction application may combine the account number and the first DSC in a queue into payment code 610. Thus, a merchant may scan payment code 610 in order to create a transaction request. In response to generating payment code 610 comprising the first DSC in the queue, the transaction application may delete the first DSC from the queue, and move the next DSC to the front of the queue.

In various embodiments, a consumer may be able to receive a payment via the transaction application on PCD 130. PCD 130 may comprise a code reader application capable of reading a payment code. For example, PCD 130 may comprise a QR reader, and the payment code may be a QR code. In various embodiments the code reader may be part of the transaction application. PCD 130 may capture an image of a payment code via a camera. In various embodiments, PCD 130 may actively scan for a QR code and may not need to capture a static image. The code reader may extract transaction information from the payment code. The transaction information may comprise a transaction account number, a security code, a DSC, a transaction amount, a billing zip code, enhanced authorization data, or any other information related to the transaction. However, in various embodiments, PCD 130 may transmit the payment code directly to CAS 110 without extracting transaction information, and CAS 110 may extract the transaction information.

Referring to FIG. 7, a flowchart is illustrated according to various embodiments. In step 710, the payment code may be generated by a payor PCD, and the payment code may be read by a payee PCD. A Payor may access a payor transaction application on the payor PCD. The payor transaction application may prompt the Payor to input a transaction amount. The payor transaction application may also prompt the Payor to input verification information. The payor transaction application may generate a payment code comprising a transaction account number associated with the Payor and a DSC. The DSC may be a single use security code as previously described. The payment code may also comprise the transaction amount. The payor PCD may display the payment code on a screen.

In step 720, the payee PCD may scan the payment code using a payee transaction application. In step 730, the payee PCD may extract transaction information from the payment code and transmit the transaction information to CAS 110. CAS 110 may parse the transaction information into the transaction account number, DSC, transaction amount, and other information. In step 740, CAS 110 may verify the transaction information. CAS 110 may compare the security code to a first DSC in a queue for the transaction account associated with the transaction account number. In response to the DSC from the transaction information matching the first DSC in the queue, CAS 110 may transmit an authorization message to the payee PCD. In various embodiments, CAS 110 may transmit a confirmation message to the payor PCD prior to authorizing the transaction.

Referring to FIG. 8, in various embodiments, a payment code 810 may be printed on a transaction instrument 820. In various embodiments, the payment code 810 may only contain information which is otherwise visible on the transaction instrument 820. For example, the payment code 910 may comprise a transaction account number or an alias, expiration date, consumer name, and a card identification number (“CID”). In various embodiments, the payment code 810 may comprise additional information such as an alias, a static security code, a billing address, or any other information. In various embodiments, transaction instrument 820 may comprise a first payment code on a first side of the transaction instrument, and a second payment code on a second side of the transaction instrument. PCD 130 may scan payment code 810 from transaction instrument 820 using camera 830. PCD 130 may prompt the owner of transaction instrument 820 to enter additional transaction information on PCD 130. The additional transaction information may comprise a signature, billing zip code, personal identification number, or any other verification information. PCD 130 may also prompt the consumer or the transaction instrument owner to enter a transaction amount. PCD 130 may transmit the transaction information to CAS 110. CAS 110 may review the transaction information and transmit an approval or denial message to PCD 130. In various embodiments, CAS 110 may transmit a confirmation message to a PCD associated with the owner of transaction instrument 820, and CAS 110 may not authorize the transaction unless the PCD associated with transaction instrument 820 transmits a confirmation to CAS 110. In various embodiments, CAS 110 transmits a DSC to the PCD associated with transaction instrument 820, and the DSC may be input to PCD 130. PCD 130 may transmit the DSC to CAS 110, and in response to the DSC matching a DSC stored by CAS 110, CAS 110 may authorize the transaction.

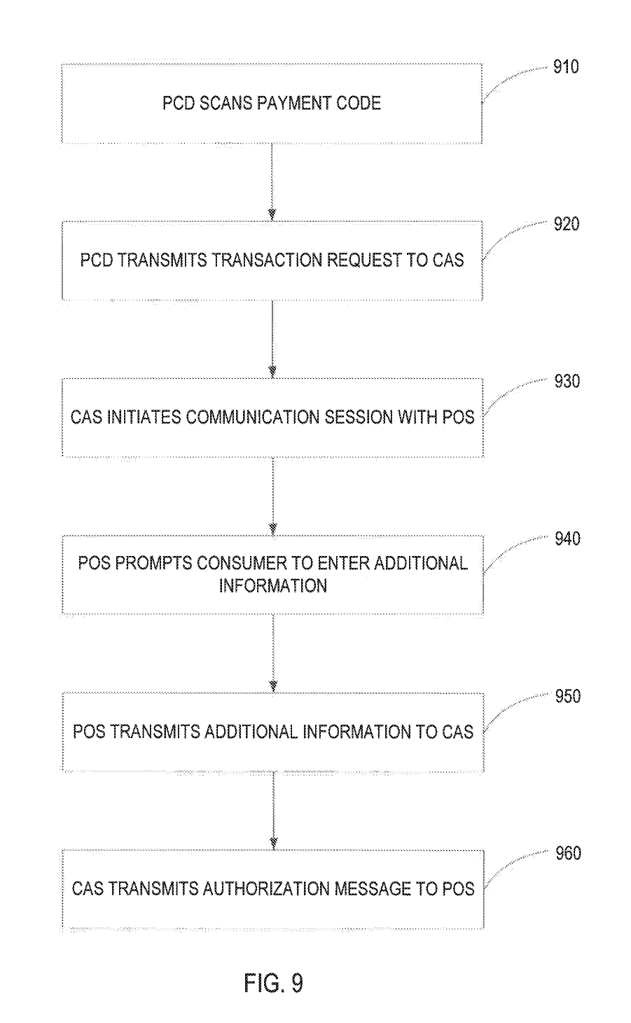

Referring to FIG. 9, a flowchart is illustrated according to various embodiments. In step 910, PCD 130 may scan a payment code located at a merchant POS. For example, a gas pump or a cash register at a merchant store may comprise a payment code which is viewable by a consumer. The payment code may be digitally produced on a screen or may be in a physical embodiment such as a sticker affixed to a gas pump. The payment code may comprise information such as a merchant account, a merchant location, a merchant service establishment number, a merchant tax identification number, or other information identifying the merchant or the specific POS. In various embodiments, the payment code may comprise dynamic information such as the date or time of day, or a transaction identifier which changes after each transaction conducted at the POS.

PCD 130 may scan the payment code and transmit a transaction request including the information contained in the payment code to CAS 110 in step 920. In various embodiments, PCD 130 may extract the information from the payment code. PCD 130 may also transmit information associated with a transaction account associated with PCD 130 to CAS 110. PCD 130 may transmit a DSC to CAS 110. The DSC may be transmitted as part of the transaction request. In step 930, CAS 110 may initiate a communication session with the POS. In various embodiments, the POS may transmit information to CAS 110 indicating a location of the POS. CAS 110 may transmit the location of POS to PCD 130. In step 940, the POS may prompt the consumer to enter additional information. The additional information may comprise verification information such as a signature, zip code, personal identification number, or other verification information. The additional information may comprise a DSC. The consumer may view the next available DSC on PCD 130 and input the DSC into the POS. In various embodiments, PCD 130 may prompt the consumer for additional information. The consumer may input the additional information into PCD 130, such as a password or personal identification number. In step 950, the POS may transmit the additional information to CAS 110, and CAS 110 may compare the additional information to corresponding information stored by CAS 110. In response to the additional information matching the corresponding information, CAS 110 may authorize the transaction and transmit an authorization message to at least one of the POS and PCD 130 in step 960. The POS may transmit a transaction amount to CAS 110 and CAS 110 may complete the transaction.

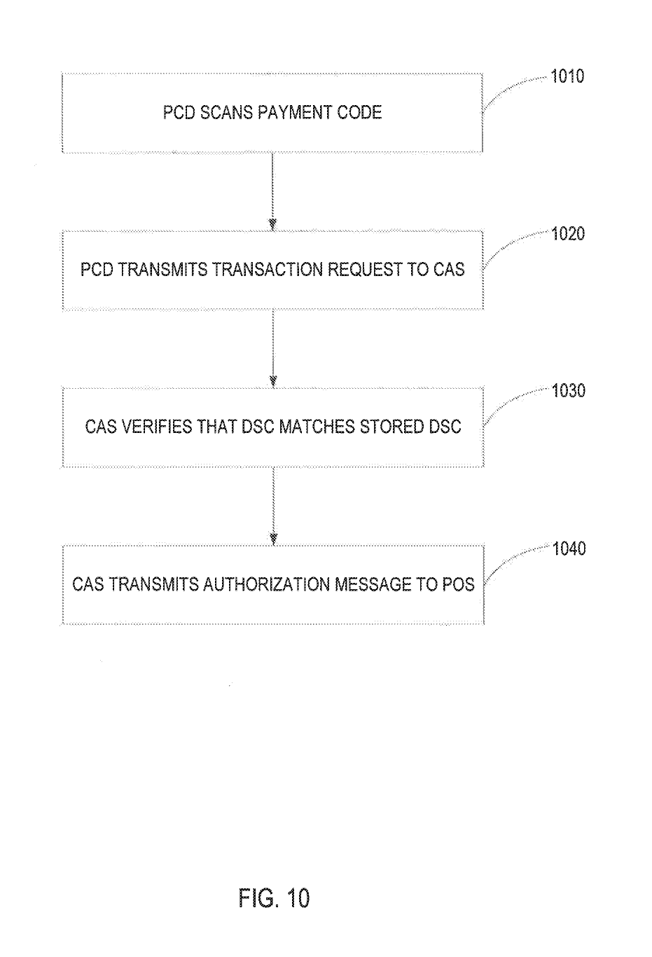

Referring to FIG. 10, a flowchart is illustrated according to various embodiments. In step 1010, PCD 130 may scan a payment code located at a merchant POS. For example, a gas pump or a cash register at a merchant store may comprise a payment code which is viewable by a consumer. The payment code may be digitally produced on a screen or may be in a physical embodiment such as a sticker affixed to a gas pump. The payment code may comprise information such as a merchant account, a merchant location, a merchant service establishment number, a merchant tax identification number, or other information identifying the merchant or the specific POS. In various embodiments, the payment code may comprise dynamic information such as the date or time of day, or a transaction identifier which changes after each transaction conducted at the POS.

PCD 130 may scan the payment code and transmit a transaction request including the information contained in the payment code to CAS 110 in step 1020. In various embodiments, PCD 130 may extract the information from the payment code. PCD 130 may also transmit information associated with a transaction account associated with PCD 130 to CAS 110. PCD 130 may transmit a DSC to CAS 110. The DSC may be transmitted as part of the transaction request. In step 1030, CAS 110 may verify that the DSC matches a DSC stored by CAS 110. In step 1040, in response to verifying that the DSC matches the stored DSC, CAS 110 may initiate a communication session with the POS. CAS 110 may transmit an authorization message to the merchant POS. In various embodiments, the POS may transmit information to CAS 110 indicating a location of the POS. CAS 110 may compare the location of POS to the location of the PCD 130.

In various embodiments, a consumer may initiate a transaction using a transaction instrument, such as a credit card. The consumer may swipe the transaction instrument at a merchant POS 140, or transmit information from the transaction instrument to the POS 140 by any other method known in the art, such as RFID. The POS 140 may prompt the consumer to enter a DSC. The consumer may access a transaction application on a PCD 130 and obtain a DSC. The consumer may input the DSC to the POS 140, and the POS 140 may transmit transaction information including the DSC to GAS 110. CAS 110 may compare the transaction information to corresponding information stored by CAS 110. In response to the transaction information matching the corresponding information, CAS 110 may authorize the transaction and transmit an authorization message to at least one of the POS and PCD 130.

In various embodiments, a consumer may wish to make a transaction via a merchant website. The consumer may enter transaction information, such as a transaction account number and other identifying information into the merchant website. The merchant website may prompt the consumer for a DSC. The consumer may access an active DSC via a transaction application on a PCD 130. The consumer may input the DSC into the merchant website, and the merchant website may transmit a transaction request to CAS 110. Many online order forms include a field for a card security identifier. A static card security number is most often printed on the back of a transaction instrument and is used to help verify that a user is in physical possession of a transaction instrument. In various embodiments, the DSC may be entered into a CID field. CAS 110 may compare the DSC from the transaction request to a confirmation CID to determine if the two match or substantially match. CAS 110 may analyze the transaction request and transmit an authorization message to the merchant website.

In various embodiments, rather than manually entering the transaction information, the consumer may connect PCD 130 to a web client, such as a personal computer, for example by a USB cord or Bluetooth® technology. PCD 130 may transmit the transaction information, including the DSC to the web client, and the merchant website may access the transaction information via the web client. In various embodiments, PCD 130 may generate a payment code, and the merchant website may transmit the payment code to CAS 110, and CAS 110 may extract the transaction information from the payment code.

Practitioners will appreciate that the systems and methods described herein, in addition to being used in the context of a merchant website, may similarly be used in the context of telephone purchases, mail order purchases, and any other purchasing scenario where face-to-face interaction is limited or nonexistent.

In various embodiments, a consumer may use a DSC to access their transaction account information. For example, when calling to make account inquiries or transactions over the phone, the consumer may be prompted to enter or speak the DSC as part of a verification process. The consumer may obtain the DSC from their PCD 130 and communicate the DSC to an operator or automated verification system. In response to the DSC matching a stored DSC, the consumer may be granted access to their account. In various embodiments, a transaction request may comprise a request to access transaction account information. When accessing transaction account information online, the consumer may be required to enter the DSC as part of the verification process.

Any communication, transmission and/or channel discussed herein may include any system or method for delivering content (e.g. data, information, metadata, etc), and/or the content itself. The content may be presented in any form or medium, and in various embodiments, the content may be delivered electronically and/or capable of being presented electronically. For example, a channel may comprise a website, a uniform resource locator (“URL”), a document (e.g., a Microsoft Word document, a Microsoft Excel document, an Adobe .pdf document, etc.), an “ebook,” an “emagazine,” an application or microapplication (as described below), an SMS or other type of text message, an email, facebook, twitter, MMS and/or other type of communication technology. In various embodiments, a channel may be hosted or provided by a data partner. In various embodiments, the distribution channel and/or the may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include Facebook®, foursquare®, Twitter®, MySpace®, LinkedIn®, and the like. Examples of affiliate or partner websites include American Express®, Groupon®, LivingSocial®, and the like. Moreover, examples of mobile device communications include texting, email, and mobile applications for smartphones.

A “consumer profile” or “consumer profile data” may comprise any information. or data about a consumer that describes an attribute associated with the consumer (e.g., a preference, an interest, demographic information, personally identifying information, and the like).

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

Phrases and terms similar to an “entity” may include any individual, consumer, customer, group, business, organization, government entity, transaction account issuer or processor (e.g., credit, charge, etc), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

Phrases and terms similar to “account”, “account number”, “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

The system may include or interface with any of the foregoing accounts, devices, and/or a transponder and reader (e.g. RFID reader) in RF communication with the transponder (which may include a fob), or communications between an initiator and a target enabled by near field communications (NFC). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an RFID reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 21481/ECMA-352, Near Field Communication Interface and Protocol-2 (NFCIP-2); and EMV 4.2 available at http://www.emvco.com/default.aspx.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

In various embodiments, an account number may identify a consumer. In addition, in various embodiments, a consumer may be identified by a variety of identifiers, including, for example, an email address, a telephone number, a cookie id, a radio frequency identifier (RFID), a biometric, and the like.

Phrases and terms similar to “transaction account” may include any account that may be used to facilitate a financial transaction.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

The terms “payment vehicle,” “financial transaction instrument,” “transaction instrument” and/or the plural form of these terms may be used interchangeably throughout to refer to a financial instrument.

Phrases and terms similar to “merchant,” “supplier” or “seller” may include any entity that receives payment or other consideration. For example, a supplier may request payment for goods sold to a buyer who holds an account with a transaction account issuer.

Phrases and terms similar to a “buyer” may include any entity that receives goods or services in exchange for consideration (e.g. financial payment). For example, a buyer may purchase, lease, rent, barter or otherwise obtain goods from a supplier and pay the supplier using a transaction account.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Phrases similar to a “payment processor” may include a company (e.g., a third party) appointed (e.g., by a merchant) to handle transactions. A payment processor may include an issuer, acquirer, authorizer and/or any other system or entity involved in the transaction process. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction.

Phrases similar to a “payment gateway” or “gateway” may include an application service provider service that authorizes payments for e-businesses, online retailers, and/or traditional brick and mortar merchants. The gateway may be the equivalent of a physical point of sale terminal located in most retail outlets. A payment gateway may protect transaction account details by encrypting sensitive information, such as transaction account numbers, to ensure that information passes securely between the customer and the merchant and also between merchant and payment processor.

Phrases similar to “vendor software” or “vendor” may include software, hardware and/or a solution provided from an external vendor (e.g., not part of the merchant) to provide value in the payment process (e.g., risk assessment).

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEB SPHERE, WEB LOGIC, JBOSS). In various embodiments, the server may include web servers (e.g. APACHE, IIS, GWS, SUN JAVA SYSTEM WEB SERVER).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network. A web-client may run Microsoft Internet Explorer, Mozilla Firefox, Google Chrome, Apple Safari, or any other of the myriad software packages available for browsing the Internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., Windows NT, 95/98/2000/CE/Mobile, OS2, UNIX, Linux, Solaris, MacOS, PalmOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/groups/SNS/cloud-computing/cloud-def-v15.doc (last visited Feb. 4, 2011), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

As used herein, “issue a debit”, “debit” or “debiting” refers to either causing the debiting of a stored value or prepaid card-type financial account, or causing the charging of a credit or charge card-type financial account, as applicable.

Phrases and terms similar to an “item” may include any good, service, information, experience, data, content, access, rental, lease, contribution, account, credit, debit, benefit, right, reward, points, coupons, credits, monetary equivalent, anything of value, something of minimal or no value, monetary value, non-monetary value and/or the like.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with various embodiments, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in various embodiments, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in various embodiments, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, GPO (GnuPG), and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In various embodiments, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix. MySQL, Interbase, etc., may be used to provide an Active Data Object (ADO) compliant database management system. In various embodiments, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript. And XML), helper applications, plug-ins, and the like. A server may include a web service that receives a request from a web server, the request including a URL (http://yahoo.com/stockquotes/ge) and an IP address (123,56,789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQTM (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C4, Java, JavaScript, VBScript, Macromedia Cold Fusion, COBOL, Microsoft Active Server Pages, assembly, PERL, PHP, ark, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the term “end user”, “consumer”, “customer”, “cardmember”, “business” or “merchant” may be used interchangeably with each other, and each shall mean any person, entity, government organization, business, machine, hardware, and/or software. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet® and the Veriphone® networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, a processing apparatus executing upgraded software, a stand alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computers readable media that are not only propagating transitory signals per se. Stated another way, the meaning of the term “non-transitory computer-readable medium” and “non-transitory computer-readable storage medium” should be construed to exclude only those types of transitory computer-readable media. which were found in In Re Nuijten to fall outside the scope of patentable subject matter under 35 U.S.C. §101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A computer-implemented method comprising:
generating, by a computer-based system capable of processing a payment, a dynamic security code;
transmitting, by the computer-based system, the dynamic security code to a portable consumer device;
receiving, by the computer-based system, a transaction request;
detecting, by the computer-based system, the dynamic security code in the transaction request; and
authorizing, by the computer-based system, the transaction request.

2. The method of claim 1, wherein the generating a dynamic security code comprises storing a plurality of dynamic security codes in a queue.

3. The method of claim 1, wherein the transmitting the dynamic security code further comprises transmitting a plurality of dynamic security codes to the portable consumer device, wherein the portable consumer device stores the plurality of dynamic security codes.

4. The method of claim 1, wherein the authorizing the transaction request is based on the detecting the dynamic security code.

5. The method of claim 1, wherein the computer-based system receives the transaction request from a merchant.

6. The method of claim 5, wherein the merchant scans a payment code on the portable consumer device to generate the transaction request.

7. The method of claim 1, further comprising receiving, by the computer-based system, the dynamic security code from a merchant.

8. The method of claim 1, further comprising deleting, by the computer-based system and in response to receiving the transaction request and the dynamic security code, the dynamic security code from a queue.

9. The method of claim 1, wherein the dynamic security code is input into a merchant website.

10. The method of claim 1, further comprising syncing, by the computer-based system, a plurality of dynamic security codes stored on the computer-based system with the portable consumer device.

11. The method of claim 1, wherein the dynamic security code is a single-use security code.

12. The method of claim 1, wherein the transaction request comprises a request to access transaction account information.

13. The method of claim 1, further comprising parsing, by the computer-based system, the transaction request into a transaction account number and the dynamic security code.

14. An article of manufacture including a non-transitory, tangible computer readable storage medium having instructions stored thereon that, in response to execution by a computer-based system capable of processing a payment using a dynamic security code, cause the computer-based system to be capable of performing operations comprising:
generating, by the computer-based system, a dynamic security code;
transmitting, by the computer-based system, the dynamic security code to a portable consumer device;
receiving, by the computer-based system, a transaction request;
detecting, by the computer-based system, the dynamic security code in the transaction request; and
authorizing, by the computer-based system, the transaction request.

15. A system comprising:
a processor capable of processing a payment using a dynamic security code,
a tangible, non-transitory memory configured to communicate with the processor, the tangible, non-transitory memory having instructions stored thereon that, in response to execution by the processor, cause the processor to be capable of performing operations comprising:
generating, by the processor, a dynamic security code;
transmitting, by the processor, the dynamic security code to a portable consumer device;
receiving, by the processor, a transaction request;
detecting, by the processor, the dynamic security code in the transaction request; and
authorizing, by the processor, the transaction request.

16. A computer-implemented method comprising:
storing, by a computer-based system capable of facilitating financial transactions using a portable consumer device, a dynamic security code;
generating, by the computer-based system, a payment code comprising the dynamic security code; and
displaying, by the computer-based system, the payment code.

17. The method of claim 16, wherein the payment code comprises a QR code.

18. The method of claim 16, wherein the payment code comprises at least one of a transaction account number, an alias, a consumer name, and an expiration date.

19. The method of claim 16, further comprising selecting, by the computer-based system, the dynamic security code from a plurality of dynamic security codes stored on the computer-based system based on the position of the dynamic security code in a queue.

20. The method of claim 16, further comprising deleting, by the computer-based system and in response to generating the payment code, the dynamic security code from a queue.
